(19) United States
(12) Patent Application Publication
(10) Pub. No.: US 2014/0316571 A1
(43) Pub. Date: Oct. 23, 2014

(54) ARTICULATION MODULE FOR A ROBOT AND CONTROL METHOD FOR THE SAME

(71) Applicant: QUANTA STORAGE INC., Taoyuan County (TW)

(72) Inventors: Yao-Ching TSAI, Taoyuan County (TW); Jen-Chen WU, Taoyuan County (TW)

(73) Assignee: QUANTA STORAGE INC., Taoyuan County (TW)

(21) Appl. No.: 14/195,119

(22) Filed: Mar. 3, 2014

(30) Foreign Application Priority Data
Apr. 22, 2013 (TW) 102114348

(51) Int. Cl. B25J 13/08

(52) U.S. Cl. CPC B25J 13/088
USPC 700/258

(57) ABSTRACT

An articulation module for robot and a control method for the same are provided. A plurality of buffer springs are sleeved on a passive element sleeved on a reduction mechanism. A sensor is sleeved on the buffer springs to form a multi-sleeved articulation module. By detecting a difference angle of the distorted buffer springs, the motor is controlled to rotate along with a resistance direction for ensuring operation safety.

This application claims the benefit of Taiwan application Serial No. 102114348, filed Apr. 22, 2013, the subject matter of which is incorporated herein by reference.

### BACKGROUND OF THE INVENTION

1. Field of the Invention

The disclosure relates in general to a robot, and more particularly to an articulation module which flexibly provides an actuation force for driving the robot, and a method for controlling the rotation of the articulation module.

2. Description of the Related Art

The robot not only possesses mobile flexibility and accurate positioning but also has the feature of continuous operation. Under the environment in which labor costs keep increasing and labor disputes are rampant, the robot has gradually become a powerful tool for manufacturing and assembling products in the production line as well as an ideal solution for replacing the labor works and reducing the manufacturing costs.

As indicated in FIG. 1, a cross-sectional view of an articulation module for robot of the prior art is shown. The articulation module 1 of the prior art mainly comprises a motor 2, an encoder 3, a reducer 4, a transmission mechanism 5, and a shaft 6 to which the motor 2, the encoder 3, the reducer 4, and the transmission mechanism 5 are serially connected. The motor 2 provides a power to rotate the shaft 6. The encoder 3, disposed behind the motor 2, records a rotation angle of the shaft 6 by detecting the rotation of the motor 2. The reducer 4 uses a reduction mechanism such as a planetary gear or a harmonic gear to reduce the rotation speed by which the motor 2 drives the shaft 6, such that the transmission mechanism 5 is rotated at a lower rotation speed. Then, the transmission mechanism 5 provides a loading driving the robot to achieve suitable speed of motion. The displacement of the robot can be accurately controlled by detecting the rotation angle of the shaft 6 recorded by the encoder 3.

The robot of the prior art uses the articulation module 1 to output a power for driving an object to a predetermined position. However, the robot may be obstructed by an object with larger loading or a worker and cannot continue to move. When an obstacle is detected by a sensor (not illustrated) of the robot, the robot may have an emergent brake and terminate the rotation of the articulation module 1 to avoid the object being damaged or the worker being injured.

However, the articulation module 1, which is composed of the motor 2, the encoder 3, the reducer 4 and the transmission mechanism 5 sequentially and serially connected to the shaft 6, has a huge weight and a large volume. The bulky articulation module 1 not only be unfavorable to the mobile flexibility but also occupies too much space in the production line. The greater mass of the articulation module 1, which tends to keep it moving and/or rotating once it has been set in motion, is unfavorable to the displacement of the robot. Besides, when the articulation module 1 rigidly drives a large object to continue an inertial motion, the articulation module 1 of the halted robot is at the risk of being crushed and damaged, and the worker being crushed by the object or the robot is unable to rescue the articulation module 1 which has terminated rotation. Thus, the articulation module for the robot still has many problems to be resolved in terms of structure and control.

### SUMMARY OF THE INVENTION

According to one embodiment of the present disclosure, an articulation module for a robot is provided. Through the multi-sleeving design of the articulation module, the volume and weight of the articulation module are reduced and mobile flexibility of the robot is increased accordingly.

To achieve an object of the present disclosure, an articulation module for a robot is provided. The articulation module for robot comprises a motor, an encoder, a reducer, a plurality of buffer springs, a drive flange, and a sensor. The motor, fixed in the hollowed interior of the housing, rotates the shaft. The encoder detects a rotation angle of the shaft. Through the use of a reduction mechanism, the reducer enables the shaft to output a lower rotation speed by which the shaft is rotated, and a passive element rotated by the shaft is sleeved on a peripheral of the reduction mechanism. The buffer springs are sleeved on a peripheral of the passive element, wherein one end of the buffer springs is fixed on the passive element such that the buffer springs are rotated along with the passive element. The drive flange has a plurality of through holes disposed thereon, wherein a portion of the through holes is connected to one end of the buffer springs such that the drive flange is rotated along with the buffer springs, and a portion of the through holes is connected to a loading. The sensor, sleeved on a peripheral of the buffer springs and fixed on the housing, detects a rotation angle of the drive flange.

According to another embodiment of the present disclosure, an articulation module for a robot is provided. The buffer springs are interlaced to form a single layer of coil springs, and a buffer force of the articulation module against an external resistance can be adjusted by changing the amount of buffer springs to provide a safe buffer space.

To achieve the said object of the present disclosure, the buffer springs are interlaced to form a single layer of coil springs, and a buffer force of the articulation module against an external resistance can be adjusted by changing the amount of buffer springs.

According to an alternate embodiment of the present disclosure, a control method of an articulation module for a robot is provided. The buffer springs are used to control the articulation module for robot to rotate along with a resistance direction of the motor to avoid the articulation module being damaged and the worker being injured for ensuring operation safety.

According to a first embodiment of the disclosure, a control method of an articulation module for a robot is provided. The control method comprises following steps. Firstly, a rotation angle of the motor is detected. Next, the rotation angle of the motor is converted to a rotation angle of the passive element. Then, a rotation angle of the drive flange is detected. Then, a difference angle between the rotation angle of the drive flange and the rotation angle of the passive element is calculated. Then, whether the difference angle is greater than the buffer angle is determined. If the difference angle is not greater than the buffer angle, then the method continues to detect a rotation angle. If the difference angle is greater than the buffer angle, then the method controls the motor to rotate to a predetermined safety angle along with a resistance direction of the motor, that is, a generation direction of the difference angle. Then, the rotation of the motor is terminated.

According to a second embodiment of the disclosure, a control method of an articulation module for a robot is provided. Firstly, a rotation angle of the motor is detected. Next, a rotation angle of the drive flange is detected. Then, a difference angle between the rotation angle of the drive flange and the rotation angle of the passive element is calculated. Then, whether the difference angle is greater than the buffer angle is determined. If the difference angle is not greater than the buffer angle, then the method continues to detect a rotation angle. If the difference angle is greater than the buffer angle, then the method controls the motor to rotate to a predetermined safety angle according to a generation direction of the difference angle. Then, the rotation of the motor is terminated.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-sectional view of an articulation module for a robot of the prior art.

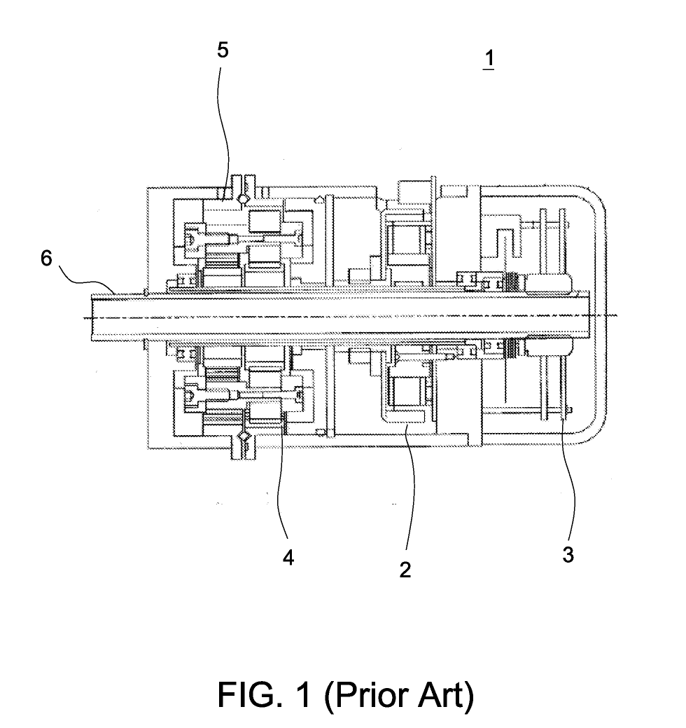

FIG. 2 is a 3D diagram of an articulation module for a robot of the disclosure.

FIG. 3 is an explosion diagram of an articulation module for a robot of the disclosure.

FIG. 4 is a cross-sectional view of an articulation module for a robot of the disclosure.

FIG. 5 is a buffer state of an articulation module for a robot of the disclosure.

FIG. 6 is a flowchart of a control method of articulation module for a robot according to a first embodiment of the disclosure.

FIG. 7 is a flowchart of a control method of articulation module for a robot according to a first embodiment of the disclosure.

### DETAILED DESCRIPTION OF THE INVENTION

The technologies adopted to achieve the above objects and effects of the said technologies are elaborated in a number of exemplary embodiments with accompanying drawings.

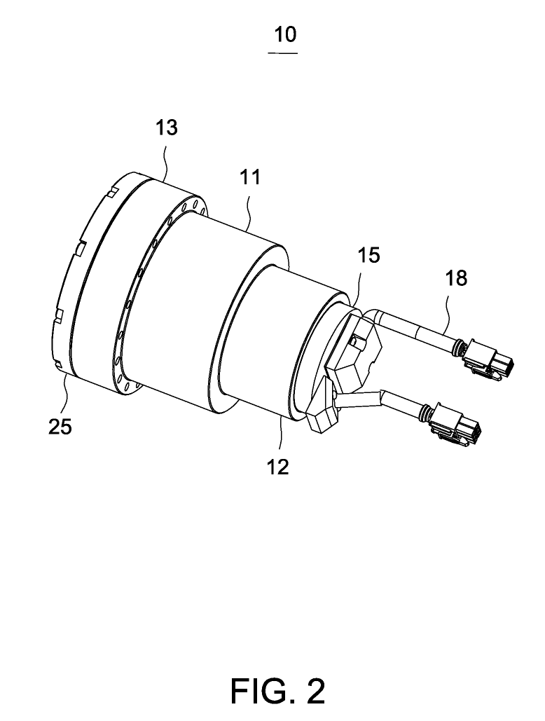

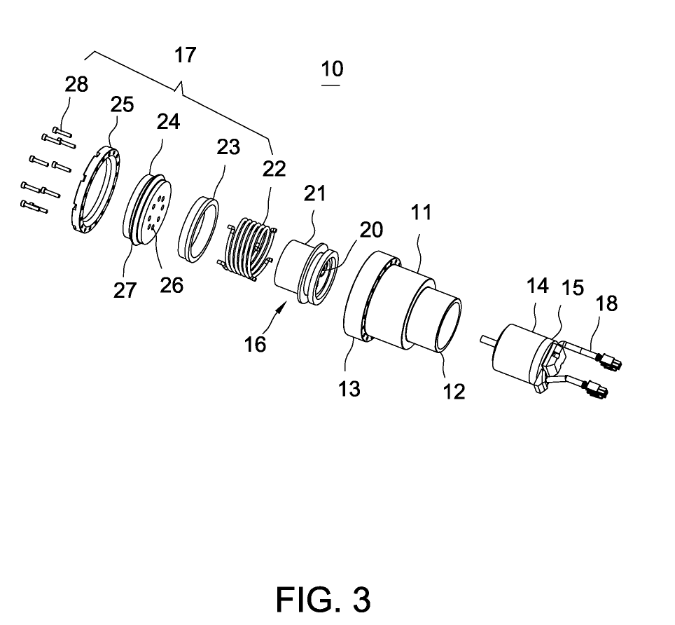

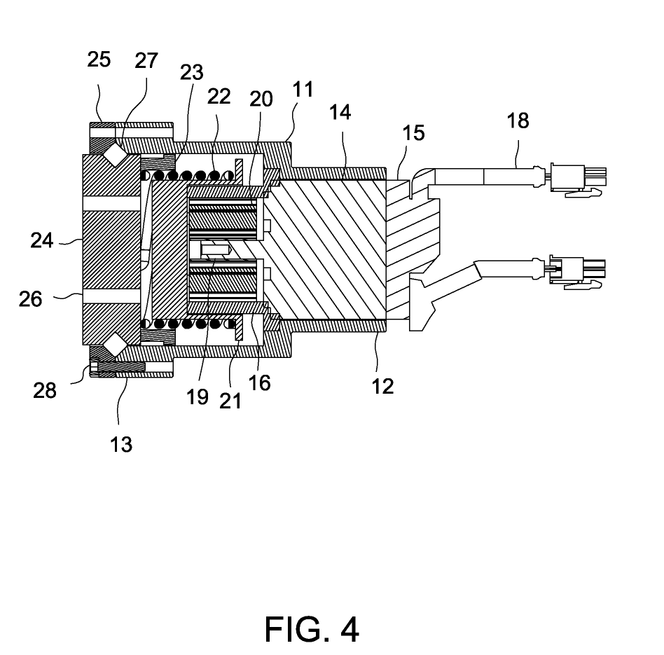

Referring to FIG. 2, FIG. 3 and FIG. 4. FIG. 2 is a 3D diagram of an articulation module for a robot of the disclosure. FIG. 3 is an explosion diagram of an articulation module for a robot of the disclosure. FIG. 4 is a cross-sectional view of an articulation module for a robot of the disclosure. The articulation module 10 of the disclosure has a hollowed housing 11. One end of the housing 11 is a fixing end 12, and the other end is an output end 13. The hollowed interior of the housing 11 accommodates a motor 14, an encoder 15, a reducer 16 and a transmission mechanism 17. The motor 14 is fixed on the fixing end 12 of the housing 11, and is connected to an external power via the cable line 18 for providing a power to rotate a shaft 19. The encoder 15 is disposed behind the motor 14, and records a rotation angle of the shaft 19 by detecting the rotation of the motor 14. The reducer 16, fixed inside the housing 11 and connected to the shaft 19 disposed in front of the motor 14, is driven to rotate by the shaft 19. Through the use of a reduction mechanism 20 such as a planetary gear or a harmonic gear, the reducer 16 enables the shaft 19 to output a lower rotation speed by which the shaft rotates the passive element 21. The passive element 21, being cylindrical and cap-shaped, is sleeved on a peripheral of the cylindrical reduction mechanism 20 and drives the transmission mechanism 17 linked to the passive element 21 to rotate.

The transmission mechanism 17 of the articulation module 10 comprises a plurality of buffer springs 22, a sensor 23, a drive flange 24 and a bearing cover 25. The buffer springs 22 are coil springs sleeved on a peripheral of the cylindrical and cap-shaped passive element 21. One end of the buffer springs 22 is fixed on the passive element 21 and is rotated along with the passive element 21, and the other end of the buffer springs 22 is connected to the drive flange 24. The transmission mechanism 17 comprises a plurality of buffer springs 22, and the buffer force of the articulation module 10 against an external resistance can be adjusted by changing the amount of buffer springs 22. The buffer springs 22 are interlaced to form one single layer of coil springs sleeved on a peripheral of the passive element 21 to reduce the volume of the articulation module. The sensor 23 is ring-shaped. The inner ring of the sensor 23 is sleeved on the peripheral of buffer springs 22 and adjacent to the end of the buffer springs 22 closer to the drive flange 24. The outer ring of the sensor 23 is fixed on an inner lateral side of the housing 11 to detect rotation angle of the drive flange 24.

The drive flange 24 is disc-shaped and has a plurality of through holes 26. A portion of the through holes 24 is connected to one end of the buffer springs 22 such that the drive flange 24 is rotated along with the buffer springs 22, and another portion of the through holes 26 is connected to a loading (not illustrated) such that the loading can be rotated. A bearing 27 is disposed on a periphery of the drive flange 24. A bolt 28 passes through a bearing cover 25 for locking the bearing cover 25 on an output end 13 of the housing 11 such that the bearing 27 is fixed on the housing 11 to support the rotation of the drive flange 24.

Referring to FIG. 4. When the articulation module 10 of the disclosure is activated, an external power is provided to the motor 14 through the cable line 18 for rotating the shaft 19. The encoder 15, disposed behind the motor 14, records a rotation angle of the shaft 19. The shaft 19 rotates the reducer 16 fixed on the housing 11. Through the use of a reduction mechanism 20, the reducer 16 enables the shaft 19 output a lower rotation speed by which the shaft rotates the passive element 21. The passive element 21, being cylindrical and cap-shaped, is sleeved on a peripheral of the cylindrical reduction mechanism 20. One end of the buffer springs 22 is fixed on the passive element 21. The buffer springs 22 are interlaced to form a single layer of coil springs sleeved on a peripheral of the passive element 21 and rotated along with the passive element 21. The other end of the buffer springs 22 drives the drive flange 24 to rotate the loading. The sensor 23, which detects rotation angle of the drive flange 24, is again sleeved on the peripheral of the buffer springs 22.

Through the multi-sleeving design of the reduction mechanism, the passive element, the buffer springs, the sensor and the formation of one single layer of interlaced buffer springs, the structure of the articulation module of the disclosure is simplified, the volume and weight of the articulation module are reduced, the inertia of the articulation module is reduced, and the mobile flexibility of the robot can thus be achieved. By changing the amount of buffer springs, the buffer force of the articulation module against an external resistance can be adjusted and an appropriate buffer space can thus be achieved.

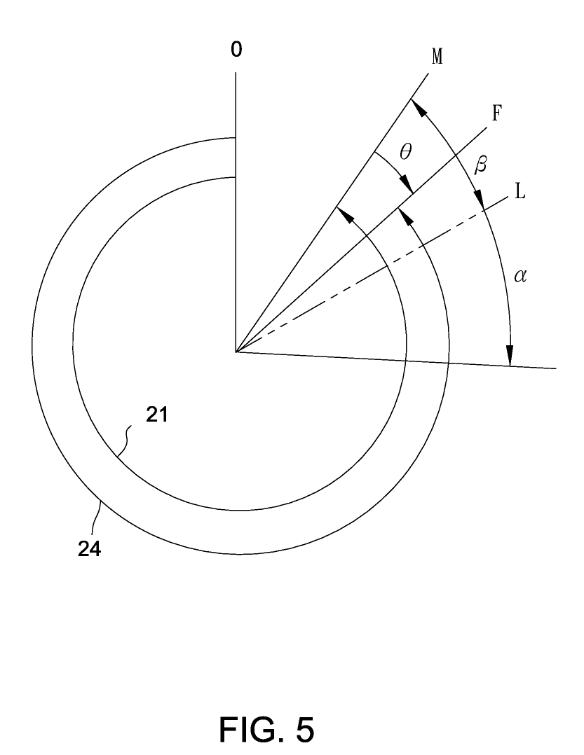

Referring to FIG. 4 and FIG. 5. FIG. 5 is a buffer state of an articulation module for a robot of the disclosure. The motor 14 rotates the shaft 19, and the reducer 16 enables the shaft 19 to output a lower rotation speed by which the shaft is rotated, and the passive element 21 (sleeved on a peripheral of the reduction mechanism) is rotated by the shaft, and a fixed reduction ratio between the motor 14 and the passive element 21 can be obtained from the design of gear ratio between the motor 14 and the passive element 21. Thus, a rotation angle of the shaft 19, which is detected and recorded by the encoder 15, is converted to a rotation angle of the passive element 21 according to the fixed reduction ratio. The passive element 21 uses the buffer springs 22 to rotate the drive flange 24. If the drive flange 24 is not obstructed when rotating a loading, the drive flange 24 is rotated along with the passive element 21, and the rotation angle of the drive flange 24 detected by the sensor 23 synchronizes the rotation angle of the passive element 21 detected by the encoder 15. The two rotation angles are the same.

Once the loading of rotating the drive flange 24 is obstructed, or the drive flange 24 is pressed when being still, the drive flange 24 and the passive element 21, which are respectively connected to two ends of the buffer springs 22, would make the buffer springs 22 distorted, such that a difference angle θ will be generated between the rotation angle F of the drive flange 24 detected by the sensor 23 and the rotation angle M of the passive element 21 detected by the encoder 15. Before the obstacle or pressure for the drive flange 24 is lifted (removed) or dismissed, the difference angle θ between the rotation angle of the drive flange 24 detected by the sensor 23 and the rotation angle of the passive element 21 detected by the encoder 15 will become larger, making the buffer springs 22 distorted further to provide a buffer space for the articulation module 10 to lift the obstacle and avoid the robot or the obstacle being damaged by the continuously rotated articulation module 10.

However, the buffer springs 22 are subject to the amount of distortion and cannot provide too much buffer space, and the robot or obstacle will eventually be damaged if the obstacle or pressure is not lifted or dismissed timely. Thus, the buffer space of the articulation module 10 of the disclosure is restricted to L, and the predetermined buffer angle of the articulation module 10 of the disclosure is restricted to 13. Let the drive flange 24 be obstructed when rotating a loading or pressed when being still, and let the difference angle θ between the rotation angle of the drive flange 24 detected by the sensor 23 and the rotation angle of the passive element 21 detected by the encoder 15 be greater than the buffer angle R. Under such circumstance, the articulation module 10 is rotated along with the resistance direction of the drive flange 24, and controls the motor 14 to rotate along with a resistance direction for rotating the passive element 21 until reaching a predetermined safety angle Δα, and then the rotation of the motor is terminated. Thus, the articulation module will not be damaged, and at the same time, the obstacle or worker will automatically be set free from danger, thereby ensuring operation safety. The resistance direction of the drive flange 24 is the generation direction of the difference angle θ.

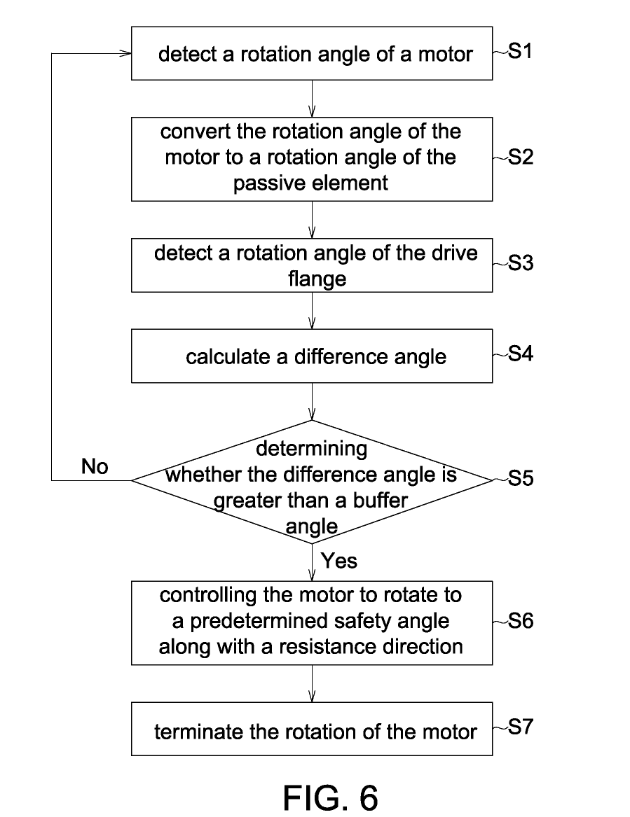

As indicated in FIG. 6, a flowchart of a control method of articulation module for a robot according to a first embodiment of the disclosure is shown. The control method comprises following steps. Firstly, the method begins in step S1, a rotation angle of the motor is detected. In step S2, the rotation angle of the motor is converted to a rotation angle of the passive element. In step S3, a rotation angle of the drive flange is detected. In step S4, a difference angle θ between the rotation angle of the drive flange and the rotation angle of the passive element is calculated. In step S5, whether the difference angle θ is greater than a predetermined buffer angle β is determined. If the difference angle θ is not greater than the buffer angle β, then the method returns to step S1 to continue the steps S1˜S4 (ex: detecting a rotation angle of the motor . . . etc.). If the difference angle θ is greater than the predetermined buffer angle β, then the method proceeds to step S6. In step 6, then the method controls the motor to rotate to a predetermined safety angle α along with a resistance direction of the motor, that is, rotated at a generation direction of the difference angle θ. In step S7, the rotation of the motor is terminated.

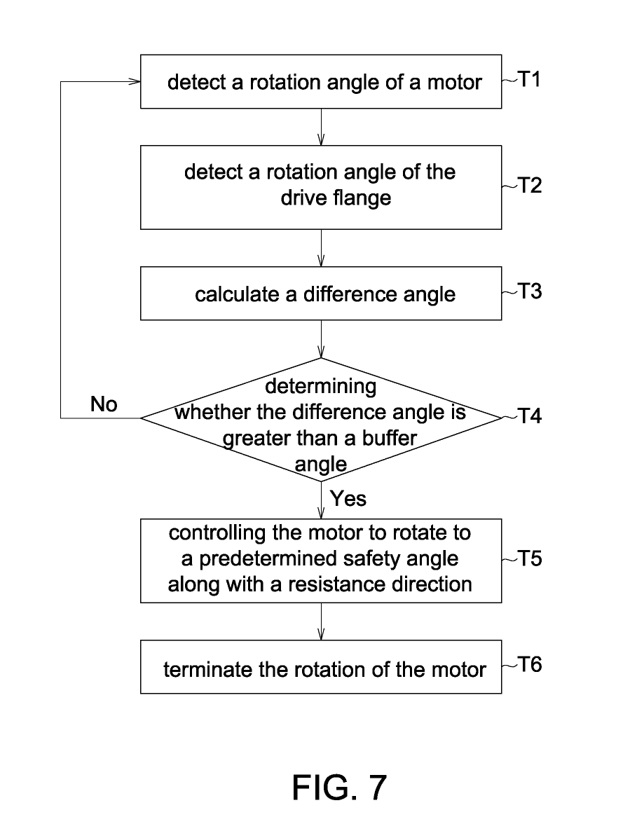

As indicated in FIG. 7, a flowchart of a control method of articulation module for a robot according to a second embodiment of the disclosure is shown. In the first embodiment, the calculation of the difference angle Δθ is based on the drive flange and the passive element respectively disposed in two ends of the buffer springs of the articulation module. The motor rotates the passive element by a rotation speed which has been reduced by the reducer. The reduction ratio between the motor and the passive element is fixed and corresponds to a rotation angle. Thus, the rotation angle of the passive element can be obtained from a rotation angle of the motor detected and recorded by the encoder according to the fixed reduction ratio, such that the conversion step S2 of the first embodiment can be largely simplified. The control method comprises following steps. Firstly, the method begins in step T1, a rotation angle of the motor is detected. In step T2, a rotation angle of the drive flange is detected. In step T3, a difference angle between the rotation angle of the drive flange and the rotation angle of the passive element is calculated. In step T4, whether the difference angle is greater than a predetermined buffer angle β is determined. If the difference angle is not greater than the buffer angle β, then the method returns to step T1 to continue the steps T1˜T4 (ex: detecting a rotation angle of the motor . . . etc.). If the difference angle is greater than the buffer angle β, then the method proceeds to step T5. In step T5, the method controls the motor to rotate to a predetermined safety angle α along with a resistance direction of the motor, that is, a generation direction of the difference angle θ. In step T6, the rotation of the motor is terminated.

According to the control method of an articulation module for robot disclosed in the disclosure, the buffer springs of the articulation module provide a buffer space when the robot is obstructed by an obstacle, and the motor is controlled to rotate to a safety angle along with a resistance when the difference angle is greater than the buffer angle. Thus, the articulation module will not be damaged, and at the same time, the obstacle or worker will be set free automatically from the danger, thereby ensuring operation safety.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An articulation module for robot having a housing, wherein hollowed interior of the housing comprises:
a motor fixed on the housing for providing a power to rotate a shaft;
an encoder for detecting a rotation angle of the shaft;
a reducer rotated by the shaft, wherein through the use of a reduction mechanism, the reducer enables the shaft to output a lower rotation speed by which the shaft is rotated, and a passive element rotated by the shaft being sleeved on a peripheral of the reduction mechanism;
a plurality of buffer springs sleeved on a peripheral of the passive element, wherein one end of the buffer springs is fixed on the passive element such that the buffer springs are rotated along with the passive element;
a drive flange having a plurality of through holes, wherein a portion of the through holes is connected to one end of the buffer springs and rotated with the buffer springs, and another portion of the through holes is connected to a loading; and
a sensor for detecting a rotation angle of the drive flange, wherein the sensor is ring-shaped with its inner ring being sleeved on the peripheral of buffer springs and its outer ring being fixed on an inner lateral side of the housing.

2. The articulation module for robot according to claim 1, wherein the passive element being cylindrical and cap-shaped, is sleeved on a peripheral of a cylindrical reduction mechanism.

3. The articulation module for robot according to claim 1, wherein the buffer springs are interlaced to form a single layer of coil springs.

4. The articulation module for robot according to claim 1, wherein the drive flange is disc-shaped and has the plurality of through holes disposed thereon.

5. The articulation module for robot according to claim 1, wherein a buffer force of the articulation module against an external resistance can be adjusted by changing an amount of buffer springs.

6. A control method of an articulation module for robot, wherein a passive element and a drive flange of the articulation module are respectively connected to two ends of plural buffer springs, a motor rotates the passive element through a reducer, and the control method comprises following steps:
(1) detecting a rotation angle of the motor;
(2) converting the rotation angle of the motor to a rotation angle of the passive element;
(3) detecting a rotation angle of the drive flange;
(4) calculating a difference angle between the rotation angle of the drive flange and the rotation angle of the passive element;
(5) determining whether the difference angle is greater than a buffer angle: if the difference angle is not greater than the buffer angle, then the method returns to step (1) to continue steps (1)˜(4), and if the difference angle is greater than the buffer angle, then the method proceeds to step (6);
(6) controlling the motor to rotate to a predetermined safety angle according to a generation direction of the difference angle;
(7) terminating the rotation of the motor.

7. The control method of an articulation module for robot according to claim 6, wherein the rotation angle of the passive element can be obtained from the rotation angle of the motor according to a fixed reduction ratio between the motor and the passive element.

8. The control method of an articulation module for robot according to claim 6, wherein the generation direction of the difference angle is the same as a resistance direction of the motor.

9. A control method of an articulation module for robot, a motor of the articulation module drives plural buffer springs to rotate a drive flange through a reducer, and the control method comprises following steps:
(1) detecting a rotation angle of the motor;
(2) detecting a rotation angle of the drive flange;
(3) calculating a difference angle between the rotation angle of the drive flange and the rotation angle of the motor;
(4) determining whether the difference angle is greater than a buffer angle: if the difference angle is not greater than the buffer angle, then the method returns to step (1) to continue steps (1)˜(4), and if the difference angle is greater than the buffer angle, then the method proceeds to step (5);
(5) controlling the motor to rotate to a predetermined safety angle according to a generation direction of the difference angle;
(6) terminating the rotation of the motor.
